(19) United States
(12) Patent Application Publication
(10) Pub. No.: US 2025/0075546 A1
(43) Pub. Date: Mar. 6, 2025

(54) HINGED COMPONENT MADE FROM HIGH DENSITY POLYETHYLENE

(71) Applicant: The Procter & Gamble Company, Cincinnati, OH (US)

(72) Inventors: Dong RUAN, BEIJING (CN); Hanjiang ZHU, BEIJING (CN); Yiping SUN, Mason, OH (US); Amy Eichstadt WAUN, Loveland, OH (US); Xu HUANG, BEIJING (CN)

(21) Appl. No.: 18/804,597

(22) Filed: Aug. 14, 2024

(30) Foreign Application Priority Data
Sep. 1, 2023 (WO) PCT/CN2023/116377

(51) Int. Cl. E05D 9/00; B29C 43/00; B29C 45/00; B29K 23/00; B29L 31/22; C08F 10/02

(52) U.S. Cl. CPC E05D 9/005; B29C 43/003; B29C 45/0001; C08F 10/02; B29K 2023/065; B29L 2031/22; C08F 2500/01; C08F 2500/07; C08F 2500/12

(57) ABSTRACT

A hinged component includes a polyethylene composition. The polyethylene composition includes high density polyethylene having a density between 0.941 g/cm³ and 0.960 g/cm³ as determined according to ASTM D792, a melt index (MI) of less than 7 g/10 min as determined according to ASTM D1238 (2.16 kg/190° C.), and a weight average molecular weight (Mw) of more than 170,000.

### FIELD OF THE INVENTION

The present application is directed to a hinged component made from high density polyethylene compositions, and methods of making the same.

### BACKGROUND OF THE INVENTION

Compared to sole screwed closure, consumers prefer a hinged closure on the bottles or tubes which can be opened by one hand thus easy to handle. For recyclable and environmental-friendly purpose, it is typical to use polyethylene such as high-density polyethylene (HDPE) material to made bottles or tubes. However, the hinged components such as hinged closures for bottles or tubes have traditionally been made with polypropylene (PP) since PP imparts high levels of durability to the hinge structure, and it is easily processed. A disadvantage for this approach is that closure made by PP cannot be recycled together with PE bottles or tubes, i.e., extra recycle step should be conducted and extra costs will be taken. Therefore, it becomes more desirable to have a closure that is made from the same type of polymer as the bottle (e.g., a polyethylene closure along with a polyethylene tube) to enable recycling of the entire package. However, polyethylene has not always been a suitable replacement of PP for hinged closure due to poor living hinge durability, especially when a high melt index is needed for polyethylene to have good processability. Thus, there is a continuous need for providing a HDPE hinged closure with desired hinge durability, as well as full recyclability together with the PE bottles or tubes associated with.

Further, the hinged component is generally used in association with tube or bottle containers containing household products or consumer products e.g., oral care products, hair care products, skin care products, personally cleanser care products, home care products, grooming products, etc., which products contain varied concentrations of surfactants and other ingredients that may affect the durability/stability of the hinged component. Thus there is a need for the hinged component to have sufficient chemical resistance properties, especially at the hinge connection points. Therefore, there is a need to provide a HDPE hinged component having desired hinge durability, full recyclability, as well as desired chemical resistance.

### SUMMARY OF THE INVENTION

The present invention meets the needs based on the surprising discovery of a hinged component made from a polyethylene composition where the polyethylene composition comprises high density polyethylene having particular properties. Such polyethylene composition provides economical and useful hinged component applications (e.g., caps and closures) while maintaining acceptable levels of performance.

In one aspect, the present invention provides a hinged component made from a polyethylene composition, where the polyethylene composition comprises high density polyethylene having a density between 0.941 g/cm³ and 0.960 g/cm³, having a melt index MI of less than 7 g/10 min, and having a weight average molecular weight (Mw) of more than 170,000.

In an embodiment of the present invention, the polyethylene composition in the hinged component has the molecular weight distribution, Mw/Mn of more than 5.

In an embodiment of the present invention, the polyethylene composition in the hinged component has a hinge life of at least 900 cycles, and preferably at least 1000 cycles.

In an embodiment of the present invention, the polyethylene composition in the hinged component of the present invention has a density of from 0.945 g/cm³ to 0.960 g/cm³, preferably from ***g/cm³ to 0.960 g/cm³, as determined according to ASTM D792.

In an embodiment of the present invention, the polyethylene composition in the hinged component of the present invention a MI of less than 6.9 g/10 min, preferably from 0.5 to 6.8 g/10 min, as determined according to ASTM D1238 (2.16 kg/190° C.).

In an embodiment of the present invention, the polyethylene composition in the hinged component of the present invention has a z-average molecular weight (Mz) of more than 800,000, preferably from 900,000 to 2,00,000, more preferably from 1,100,000 to 2,000,000.

In another aspect, the present invention provides a process for making a hinged component wherein the process comprises at least one compression molding or injection molding step and wherein the hinged component comprises a polyethylene composition having a melt index MI of less than 7 g/10 min, and a weight average molecular weight (Mw) of more than 170,000.

It is an advantage of the hinged component of the present invention to provide desirable chemistry resistance.

It is an advantage of the hinged component of the present invention to provide improved or desirable hinge life cycles.

It is an advantage of the hinged component of the present invention being capable to be recycled together with other parts associated therewith.

It is an advantage of the hinged component of the present invention to provide molding feasibility during manufacturing.

Still another advantage of the present invention is to utilize single, unblended polyethylene composition for simplified manufacturing process.

Further advantages may include cost saving for capital investment, easy to handle by one hand which is friendly to e.g., elder people or disabled people, etc.

These and other features, aspects and advantages of specific embodiments will become evident to those skilled in the art from a reading of the present invention.

### BRIEF DESCRIPTION OF THE DRAWINGS

The embodiments set forth in the drawings are illustrative in nature and not intended to limit the invention defined by the claims. The following detailed description of the illustrative embodiments can be understood when read in conjunction with the following drawings, and in which:

FIGS. 1-8 illustrates gel permeation chromatographs (GPC) for the polyethylene compositions used in Inventive Examples 1 to 4, and Comparative Examples A to D respectively. Specifically,

FIG. 1 shows the GPC for the polyethylene compositions used in Inventive Example 1, with differential molar mass distribution plotted against Log M.

FIG. 2 shows the GPC for the polyethylene compositions used in Inventive Example 2, with differential molar mass distribution plotted against Log M.

FIG. 3 shows the GPC for the polyethylene compositions used in Inventive Example 3, with differential molar mass distribution plotted against Log M.

FIG. 4 shows the GPC for the polyethylene compositions used in Inventive Example 4, with differential molar mass distribution plotted against Log M.

FIG. 5 shows the GPC for the polyethylene compositions used in Comparative Example A, with differential molar mass distribution plotted against Log M.

FIG. 6 shows the GPC for the polyethylene compositions used in Comparative Example B, with differential molar mass distribution plotted against Log M.

FIG. 7 shows the GPC for the polyethylene compositions used in Comparative Example C, with differential molar mass distribution plotted against Log M.

FIG. 8 shows the GPC for the polyethylene compositions used in Comparative Example D, with differential molar mass distribution plotted against Log M.

### DETAILED DESCRIPTION OF THE INVENTION

The following text sets forth a broad description of numerous different embodiments of the present invention. The description is to be construed as exemplary only and does not describe every possible embodiment since describing every possible embodiment would be impractical, if not impossible. It will be understood that any feature, characteristic, component, composition, ingredient, product, step or methodology described herein can be combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

As used herein, the terms “consisting essentially of” means that the composition contains less than about 1%, preferably less than about 0.5%, of ingredients other than those listed.

Further, the terms “essentially free of,” “substantially free of” or “substantially free from” means that the indicated material is present in the amount of from 0 wt % to about 0.5 wt %, or preferably from 0 wt % to about 0.1 wt %, or more preferably from 0 wt % to about 0.01 wt %, and most preferably it is not present at analytically detectable levels.

### Polyethylene Composition

One aspect of the present invention relates to a hinged component made from a polyethylene composition. The polyethylene composition comprises high density polyethylene.

The polyethylene composition of the present invention comprising high density polyethylene which has a density from 0.941 to 0.960 g/cm³, and a melt index (MI) of less than about 7 g/10 min, and a weight average molecular weight (Mw) of no less than 170,000.

In an embodiment of the present invention, the polyethylene composition has a density from 0.941 to 0.960 g/cm³, as determined according to ASTM D792. In preferred embodiments, the polyethylene composition has a density of from 0.945 to 0.960 g/cm³.

In an embodiment of the present invention, the polyethylene composition has a melt index (MI), as determined according to ASTM D1238 (2.16 kg/190° C.) of less than about 7 g/10 min. In further embodiments of the present invention, the polyethylene composition has a melt index, MI, as determined according to ASTM D1238 (2.16 kg/190° C.) of less than about 6.9 g/10 min, or less than about 6.8 g/10 min.

In an embodiment of the present invention, the polyethylene composition has a melt index, MI, as determined according to ASTM D1238 (2.16 kg/190° C.) of from 0.5 to 6.9 g/10 min. In further embodiments of the present invention, the polyethylene composition has a melt index, MI, as determined according to ASTM D1238 (2.16 kg/190° C.) of from 0.5 to 6.8 g/10 min, or from 0.6 to 6.7 g/10 min.

In an embodiment of the present invention, the polyethylene composition has a weight average molecular weight (Mw) of no less than 170,000. In other embodiments of the present invention, the polyethylene composition has a weight average molecular weight (Mw) from about 170,000, to about 300,000, or from about 170,000 to about 260,000, or from about 170,000 to about 250,000.

In an embodiment of the present invention, the polyethylene composition has the molecular weight distribution, Mw/Mn of more than 5. Preferably, the polyethylene composition has the molecular weight distribution, Mw/Mn of more than 5.5, more preferably more than 6.

In an embodiment of the present invention, the polyethylene composition has Elongation at break (%) of more than 500.

In an embodiment of the present invention, the hinged component has a hinge life of at least 1000 cycles. Preferably, the hinged component has a hinge life of more than 1100 cycles, more preferably more than 1200 cycles.

In an embodiment of the present invention, the hinged component has chemical resistance (in 5% SLSS) of more than 10 days at 60° C. Preferably, the hinged component has chemical resistance (in 5% SLSS) of more than 12 days at 60° C., more preferably more than 15 days. The chemical resistance is measured according to the test method described in below Test Method 6.

In an embodiment of the present invention, the polyethylene composition has a z-average molecular weight (Mz) of more than 800,000, preferably from 900,000 to 2,00,000, more preferably from 1,100,000 to 2,000,000.

Optionally, additives can be added to the polyethylene composition.

Additives can be added to the polyethylene composition during an extrusion or compounding step, but other suitable known methods will be apparent to a person skilled in the art. The additives can be added as is or added during an extrusion or compounding step. Suitable additives are known in the art and include but are not-limited to nucleating agents, antioxidants, phosphites and phosphonites, nitrones, antacids, UV light stabilizers, UV absorbers, metal deactivators, dyes, fillers and reinforcing agents, nano-scale organic or inorganic materials, antistatic agents, lubricating agents such as calcium stearates, slip additives such as erucimide or behenamide, and nucleating agents (including nucleators, pigments or any other chemicals which may provide a nucleating effect to the high density polyethylene composition). The additives that can be optionally added are typically added in amount of from about 5 parts per million (ppm) to about 10,000 ppm based on the weight of the polyethylene polymer.

In an embodiment of the present invention, the polyethylene composition further comprises a nucleating agent or a mixture of nucleating agents.

In an embodiment of the present invention, an additive such as nucleating agent may be added to the polyethylene composition by way of a “masterbatch”, where the term “masterbatch” refers to the practice of first melt mixing the additive (e.g., a nucleator) with a small amount of the polyethylene composition, followed by melt mixing the “masterbatch” with the remaining bulk of the unimodal polyethylene composition.

In an embodiment of the present invention, the polyethylene compositions described above are used in the formation of molded articles. For example, articles formed by continuous compression molding and injection molding are contemplated. Such articles include, for example, caps, hinged caps, screw caps, closures and hinged closures for bottles.

### Hinged Component

In an embodiment of the present invention, the polyethylene compositions described herein are used in the formation of a hinged component.

In an embodiment of the present invention, the hinged component can be a part of a cap or closure or it can be a cap or closure per se.

The hinged component, can be made according to any known method, including for example injection molding and compression molding techniques that are well known to persons skilled in the art. Hence, in an embodiment of the present invention a hinged component comprising the polyethylene composition defined herein is prepared with a process comprising at least one compression molding step and/or at least one injection molding step.

In an embodiment of the present invention, the polyethylene compositions described herein are used in a process to make a hinged component. Such processes include, for example, compression molding (or continuous compression molding) and injection molding.

In an embodiment of the present invention, a hinged component is a component consisting of at least two bodies which are connected to one another through a flexible hinge. The flexible hinge may be a continuous, partial or segmented section (which is typically thinner than the two or more bodies), so as to act as a fulcrum or pivot point about which the two or more bodies may bend. For example, the two or more bodies may bend about the flexible hinge from a molded position into a flexed position.

Examples of hinged components include caps or closures having a single strap, dual strap, multi strap or butterfly strap designs.

In an embodiment of the present invention the hinged component is a hinged cap or closure, or the like for bottles, containers and the like. Caps and closures may be formed by continuous compression molding or by injection molding. Such closures include, for example, hinged caps, hinged screw caps, hinged snap-top caps, and hinged closures for bottles, containers and the like.

In an embodiment of the present invention, a hinged component is a closure (or cap) comprising a hinge made of the same material as the rest of the closure (or cap).

In an embodiment of the present invention, a hinged component is a hinged closure (or cap).

In an embodiment of the present invention, a hinged component is a hinged closure (or cap) for bottles, containers and the like.

In an embodiment of the present invention, a hinged component is a flip-top hinge closure, such as a flip-top hinge closure for use on a plastic ketchup bottle or similar containers containing foodstuffs.

When a closure is a hinged closure, it may comprise a hinged component and generally comprises at least two bodies which are connected by a thinner section that acts as a hinge allowing the at least two bodies to bend from an initially molded position. The thinner section may, for example, be continuous or web-like, wide or narrow.

A useful hinged component is a hinged closure (for bottles, containers and the like) and may consist of two bodies joined to each other by at least one thinner bendable portion (e.g. the two bodies can be joined by a single bridging portion, or more than one bridging portion, or by a webbed portion, etc.). A first body may contain a dispensing hole and which may snap onto or screw onto a container to cover a container opening (e.g. a bottle opening) while a second body may serve as a snap on lid which may mate with the first body.

Hinged caps and closures can be made according to any known method, including for example injection molding and compression molding techniques that are well known to persons skilled in the art. Hence, in an embodiment of the present invention a hinged closure (or cap) comprising the polyethylene composition is prepared with a process comprising at least one continuous compression molding step and/or at least one injection molding step.

The hinged closures and caps of this present invention may be used for sealing bottles, containers and the like, for examples bottles that may contain drinkable water, and other foodstuffs, including but not limited to liquids that are non-pressurized. The hinged closures and caps may also be used for sealing bottles containing drinkable water or non-carbonated beverages (e.g. juice). Other applications, include hinged caps and closures for bottles and containers containing foodstuffs, such as for example ketchup bottles and the like.

The invention is further illustrated by the following non-limiting examples.

### Test Methods

Unless otherwise stated, the following test methods are used. All test methods are current as of the filing date of this disclosure.

### 1.Density

Measurements are made according to ASTM D792, Method B.

### 2. Melt Index

Melt index, MI for ethylene-based polymers is determined according to ASTM D1238 at 190° C., 2.16 kg.

### 3. GPC Molecular Weight Distribution Test Method

This method is applicable for the Molecular Weight Distribution Analysis of Polyolefins by HT-GPC-RI both as virgin material and in post-consumer recycled (PCR) material.

| | SUGGESTED TYPE OR SOURCE |
|---|---|
| | (Equivalent Items May be |
| APPARATUS | Used Unless Specified) |
| Analytical Balance | Mettler Toledo XS205 |
| HT Aluminum foil 30 mm square | Tosoh part #: 23810 |
| 10 mL Glass Vial with PTFE cap | Tosoh part #: 23809 |
| 20 mL Glass Vial | |
| Sample Heat Block | Heat Block to 135° C. |
| Filter 10 um | |
| GPC column | Agilent PLGel Mixed B; |
| | PL1110-6200 7.5 × 300 mm |

REAGENTS AND SOLUTIONS (Equivalent Items May be Used)

| Description | Grade/Supplier |
|---|---|
| o-Dichlorobenzene (DCB) | HPLC grade |
| 3,5-Di-tert-4- | Analytical grade |
| butylhydroxytoluene (BHT) | |
| Polystyrene Standards | 10 PolyStyrene Standards; Agilent |
| | EasiCal PS-1 (Standard A/B, part #: |
| | PL2010-0501) For relative Mw |
| | determination |

### Reagents Preparation:

Mobile Phase: 1,2,4 Trichlorobenzene with 0.25% BHT
500 mg BHT+2 L TCB (or DCB)
Mix thoroughly.

### Standard Preparation:

1. Cut 2 tabs from Agilent EasiCal PS-1, Standard A into a 10 mL vial.
2. Cut 2 tabs from Agilent EasiCal PS-1, Standard B into a 10 mL vial.
3. Add 8 mL Mobile phase to each vial.

### Sample Preparation:

1. Clean sample vials before use (water wash 3×, acetone wash 2×)
2. Sample concentration should be 1-2 mg/mL
3. For clean virgin resins, add 8-16 mg of sample to a 10 mL vial. Add 8 mL of mobile phase.
4. For samples that may not be clean and will need to be filtered, add 16-32 mg of sample to 20 mL glass vial. Add 16 mL of mobile phase.
5. Cap samples and place on heat block at 135° C. until dissolve (30-60 minutes).
6. Mix samples and filter if needed.
7. Transfer vials to HT-GPC system when system is at operational temperature.

### Equipment:

| | |
|---|---|
| HT-GPC System | Ecosec HT-GPC, Tosoh Bioscience |
| Columns | 3 Agilent PLGel Mixed-B in series with |
| | guard column; 300 × 7.5 mm PL1110-6200 |
| Column Temperature | 150° C. |
| Mobile Phase | DCB with 0.25% BHT |
| Runtime | 60 minutes |
| Injection volume | 300 μL |
| Autosampler Temperature | 135° C. |
| Detector | Tosoh RI |
| Detector Temp | 150° C. |
| Flow Rate | 1.0 mL/min |

### Operation:

A solvent blank and Standards A and B must be injected at the beginning and end of each run.

### 4. Test Method of Elongation at Break (%)

1) Test Strip Preparation by Hot-Pressing Molding

HDPE raw material was softened and repeatedly mixed through double drum mixing machine at 150-160° C., 15 ramp/min for 5 min. Then, the material was further mixed until it forms a uniform paste, while the space between drums gradually narrowed down and the drum speed reduced to 10 ramp/min. Suitable amount of melted paste was transferred into 1 mm×20 cm×20 cm model and placed into plate vulcanizing machine. The temperature of plate vulcanizing machine was set at 20° C. above the temperature of double drum mixing machine. When the internal temperature of the material reaches the set temperature, the material was molded with 12 Mpa pressure and hold for 3 min. The molded HDPE plate was allowed to cool and crystallize, and then placed back to plate vulcanizing machine for tempering. Temperature programing of tempering: starting from room temperature; increasing temperature at 5° C./min to 90° C. and hold for 30 min; cooling at 3° C./min to room temperature.
2) Tensile Test

The hot-pressing molded HDPE plate (1 mm thick) was cut into dumbbell shape test strips by a standard dumbbell-shape cutter (show in figure below). A universal tensile machine is used for tensile testing. Tensile speed was set at 100 mm/min. Elongation at Break (% ε) was calculated as the relative increase in length at complete breakage, % ε=(l_{b}/l₀)×100%, where l_{b} is the length of the narrow part of test strips at break, where l0 is the initial length of the narrow part of test strips (I₀=40 mm).

### 5. Method for Living Hinge Durability, i.e., Hinge Cycle Test

This method uses visual inspection to assess the durability of a hinged flip-top closure after repeated opening and closing. The repeated opening and closing can be performed manually or mechanically to eliminate any possibility of repetitive stress injury. Specifically, the method of open and close flip-top cap is conducted as following:

Unseat the flip-top cap by placing tester's finger on top of the closure near the hinge and applying upward force with the thumb on the underside of the lift tab and then moving the lid to the full open position, typically a 180 degrees rotation. Close the lid by pressing on the top side of the lift tab with a finger. Test is conducted at room temperature, with a rate/speed of 1 cycle/sec. Inspect hinge for breakage after each open/closed cycle. Open and close the flip-top cap at desired cycling numbers (e.g., 500 times, 800 times, 1000 times), or until hinge break observed.

### 6. Method for Chemical Resistance to Surfactant

Hinge caps made of each sample of polyethylene compositions (4 of each material) are immersed in 5% sodium lauryl sulfate solution (w/w) and incubated in 60° C. The caps are observed daily on crack development.

### EXAMPLES

The embodiments described herein may be further illustrated by the following non-limiting examples.

### 1. Example Preparation

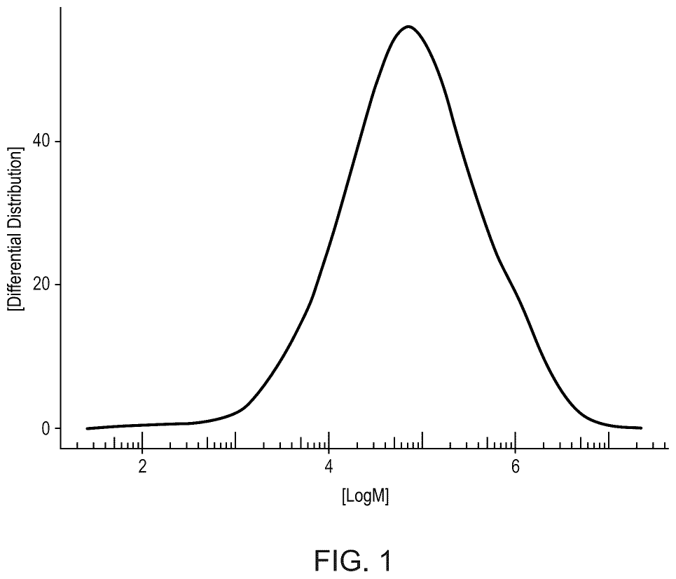

Inventive Example 1 is a hinged component made from a polyethylene composition having a melt index MI of 1.45 g/10 min, a density of 0.954 g/cm³, and a weight average molecular weight (Mw) of 292506, and a molecular weight distribution MWD (Mw/Mn) of 25.7. The Inventive Example 1 is made by injection molding of the said polyethylene composition. A GPC profile for the resin is given in FIG. 1.

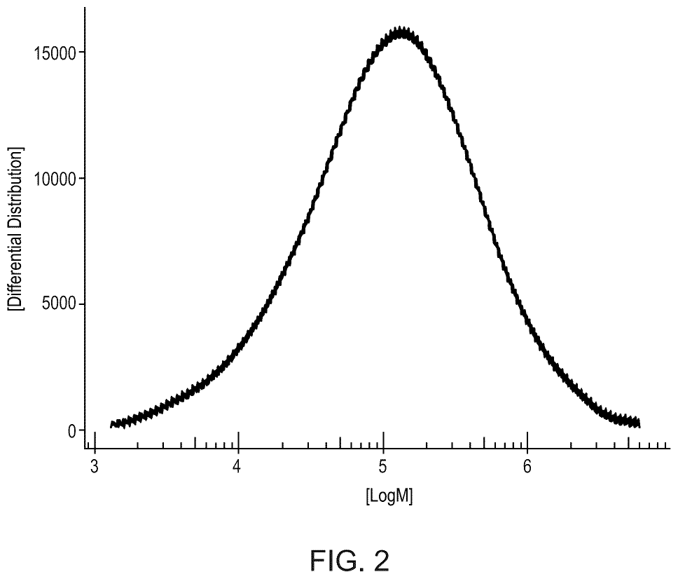

Inventive Example 2 is a hinged component made from a polyethylene composition having a melt index MI of 2.1 g/10 min, a density of 0.953 g/cm³, and a weight average molecular weight (Mw) of 270000, and a molecular weight distribution MWD (Mw/Mn) of 6.6. The Inventive Example 2 is made by injection molding of the said polyethylene composition. A GPC profile for the resin is given in FIG. 2.

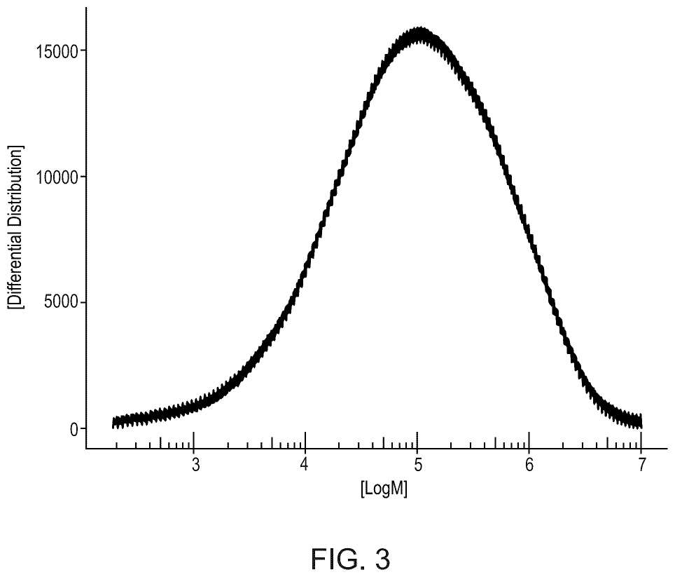

Inventive Example 3 is a hinged component made from a polyethylene composition having a melt index MI of 0.8 g/10 min, a density of 0.956 g/cm³, and a weight average molecular weight (Mw) of 348014, and a molecular weight distribution MWD (Mw/Mn) of 23.3. The Inventive Example 3 is made by injection molding of the said polyethylene composition. A GPC profile for the resin is given in FIG. 3.

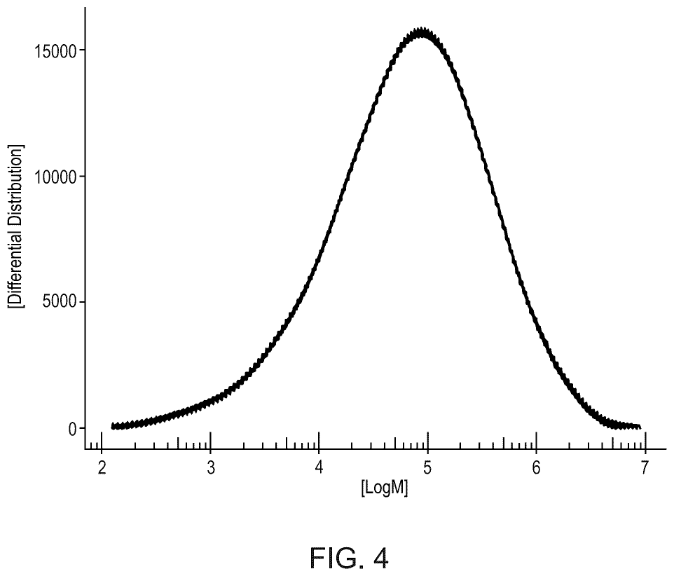

Inventive Example 4 is a hinged component made from a polyethylene composition having a melt index MI of 4 g/10 min, a density of 0.958 g/cm³, and a weight average molecular weight (Mw) of 218538, and a molecular weight distribution MWD (Mw/Mn) of 18.5. The Inventive Example 4 is made by injection molding of the said polyethylene composition. A GPC profile for the resin is given in FIG. 4.

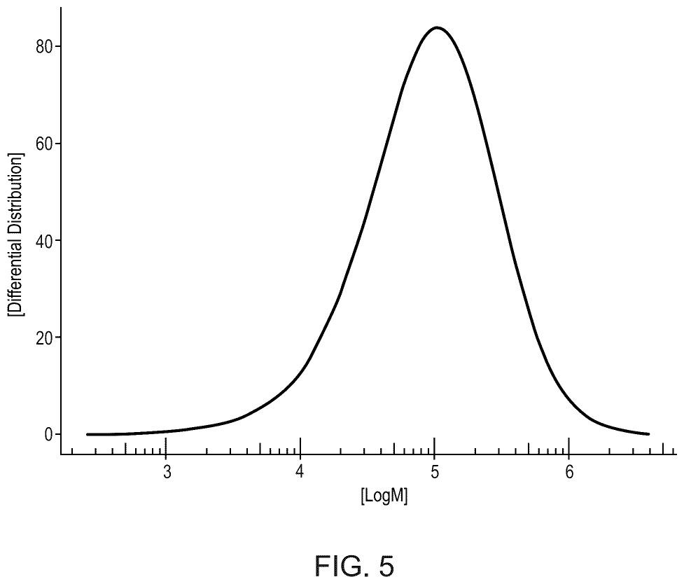

Comparative Example A is a hinged component made from a polyethylene composition having a melt index MI of 8 g/10 min (which is more than 7 g/10 min), a density of 0.964 g/cm³ (which is higher than 0.960 g/cm³), and a weight average molecular weight (Mw) of 164167 (which is less than 170000), which scope of properties falls out of the inventive scope of the present invention. The Comparative Example A is made by injection molding of the said polyethylene composition. A GPC profile for the resin is given in FIG. 5.

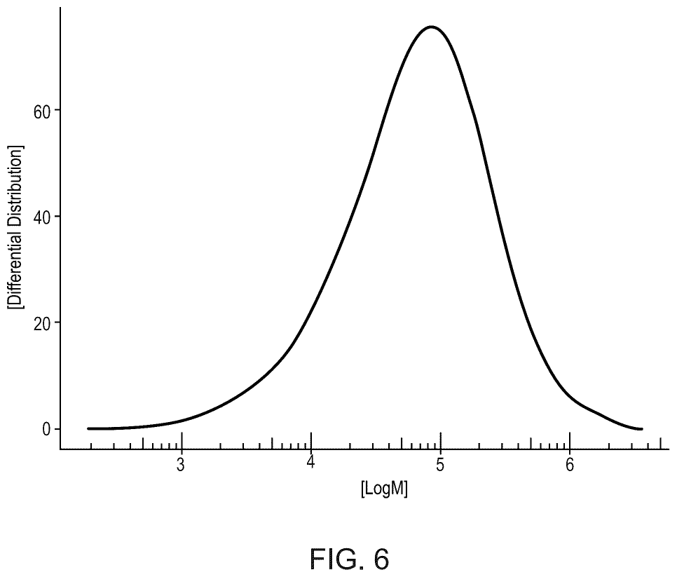

Comparative Example B is a hinged component made from a polyethylene composition having a melt index MI of 18 g/10 min (which is more than 7 g/10 min), a density of 0.958 g/cm³, and a weight average molecular weight (Mw) of 138042 (which is less than 170000), which scope of properties falls out of the inventive scope of the present invention. The Comparative Example B is made by injection molding of the said polyethylene composition. A GPC profile for the resin is given in FIG. 6.

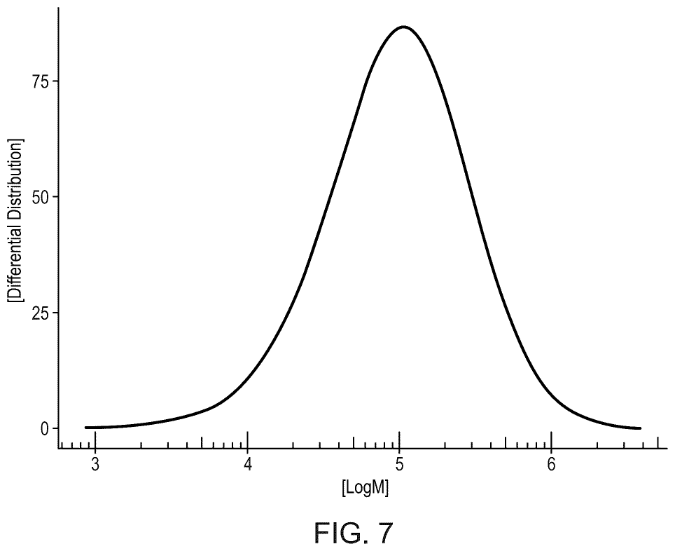

Comparative Example C is a hinged component made from a polyethylene composition having a melt index MI of 6.7 g/10 min, a density of 0.952 g/cm³, and a weight average molecular weight (Mw) of 168871 (which is less than 170000), which scope of properties falls out of the inventive scope of the present invention. The Comparative Example C is made by injection molding of the said polyethylene composition. A GPC profile for the resin is given in FIG. 7.

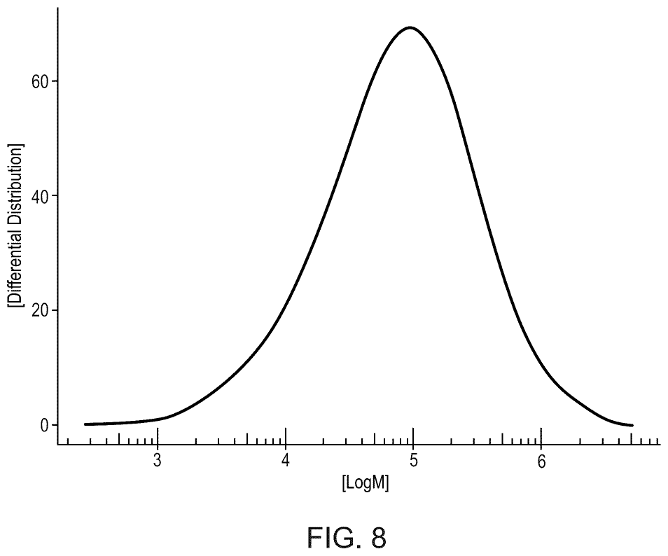

Comparative Example D is a hinged component made from a polyethylene composition having a melt index MI of 8 g/10 min (which is more than 7 g/10 min), a density of 0.960 g/cm³, and a weight average molecular weight (Mw) of 177816, which scope of properties falls out of the inventive scope of the present invention. The Comparative Example D is made by injection molding of the said polyethylene composition. A GPC profile for the resin is given in FIG. 8.

The properties of the inventive and comparative polyethylene components are listed together in Table 1 with specific properties below.

TABLE 1

| | Inventive &Comparative Polyethylene Component Properties | | | | | | | |
|---|---|---|---|---|---|---|---|---|
| Example No. | Inv. 1 | Inv. 2 | Inv. 3 | Inv. 4 | Comp. A | Comp. B | Comp. C | Comp. D |

Polyethylene composition

| | | | | | | | | |
|---|---|---|---|---|---|---|---|---|
| Density (g/cm³) | 0.954 | 0.953 | 0.956 | 0.958 | 0.964 | 0.958 | 0.952 | 0.960 |
| MI (g/10 min at | 1.45 | 2.1 | 0.8 | 4 | 8 | 18 | 6.7 | 8 |
| 2.16 kg/190° C.) | | | | | | | | |
| Mw | 292506 | 272408 | 348014 | 218538 | 164147 | 138042 | 168871 | 177816 |
| Mn | 11385 | 41400 | 14908 | 11792 | 38220 | 21976 | 47100 | 25707 |
| MWD (Mw/Mn) | 25.7 | 6.6 | 23.3 | 18.5 | 4.3 | 6.3 | 3.6 | 6.9 |
| Mz | 2146673 | 1080242 | 1862409 | 1201527 | 466861 | 478557 | 465318 | 679110 |

### Example 2. Elongation at Break (%) Test

Elongation at break (%) Test is conducted to measure the strength of the polyethylene composition material and the higher the value of Elongation at break, the better the strength of the material is. The test method is described in hereinabove. The value of Elongation at break of the material for Inventive Examples 1 to 4 and Comparative Examples A to C are listed in below Table 2.

TABLE 2
Elongation at break

| Example | Inv. | Inv. | Inv. | Inv. | Comp. | Comp. | Comp. |
|---|---|---|---|---|---|---|---|
| No. | 1 | 2 | 3 | 4 | A | B | C |
| Elongation | 984 | 1188 | 1069 | 1057 | 91 | 19 | 378 |
| at break (%) | | | | | | | |

It can be seen clearly from the results that the Inventive Examples 1 to 4 who has desirable Mw, density and MI provide much larger value of elongation at break thus provide better strength to the hinged components made by such inventive Examples.

### Example 3. Hinge Cycle Test

Hinge cycle Test for Inventive Examples 1 to 4 which are made by injection molding to a hinged cap are conducted, together with Comparative Examples A to D. Test method has been described in above TEST METHOD 5.

TABLE 3
Hinge cycle

| Example No. | Inv. 1 | Inv. 2 | Inv. 3 | Inv. 4 | Comp. A | Comp. B | Comp. C | Comp. D |
|---|---|---|---|---|---|---|---|---|
| Hinge cycle 500 times | Pass | Pass | Pass | Pass | Break (<300) | Pass | Pass | Break |
| Hinge cycle 800 times | Pass | Pass | Pass | Pass | — | Pass | Pass | — |
| Hinge cycle 1000 times | Pass | Pass | Pass | Pass | — | Break | Break | — |

It can be seen from the results of Hinge Cycle Test that all the Inventive Examples exhibit excellent hinge cycle properties which are desired for hinged cap. Comparative Example A which does not have desired MI, Density and Mw shows a very poor hinge cycle performance.

### Example 4. Chemical Resistance Test

Chemical Resistance is very important for a hinged component which is used together with containers containing surfactants or other ingredients. It directs to the stability of a hinged component. The test for Inventive Examples 1 to 4 and Comparative Examples A to C are conducted according to the method described in TEST METHOD 6 and the results are listed in below Table 4.

TABLE 4
chemical resistance

| Example No. | Inv. 1 | Inv. 2 | Inv. 3 | Inv. 4 | Comp. A | Comp. B | Comp. C |
|---|---|---|---|---|---|---|---|
| Chemical Resistance | >27 days | 18 days | >27 days | 11 days | 0 day | 3 days | 5 days |
| (5% SLSS, 60° C.) | | | | | | | |

It can be seen from the results that the inventive Examples 1 to 4 exhibit excellent resistance even in high temperature 60° C. thus are stable even in long shelf life. However, the comparative examples show breakage in less than a few days.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A hinged component comprising:
a polyethylene composition, wherein the polyethylene composition comprises high density polyethylene having:
a density between 0.941 g/cm³ and 0.960 g/cm³ as determined according to ASTM D792,
a melt index (MI) of less than 7 g/10 min as determined according to ASTM D1238 (2.16 kg/190° C.), and
a weight average molecular weight (Mw) of more than 170,000.

2. The hinged component of claim 1, wherein the polyethylene composition has the molecular weight distribution, Mw/Mn of more than 5.

3. The hinged component of claim 1, wherein the polyethylene composition has Elongation at break (%) of more than 500.

4. The hinged component of claim 1, wherein the hinged component has a hinge life of at least 1000 cycles.

5. The hinged component of claim 1, wherein the hinged component has chemical resistance of more than 10 days at 60° C.

6. The hinged component of claim 1, wherein the polyethylene composition has a z-average molecular weight (Mz) of more than 800,000.

7. The hinged component of claim 6, wherein the Mz is from 900,000 to 2,00,000.

8. The hinged component of claim 6, wherein the Mz is from 1,100,000 to 2,000,000.

9. The hinged component of claim 1, wherein the polyethylene composition has a density of from 0.945 g/cm³ to 0.960 g/cm³, as determined according to ASTM D792.

10. The hinged component of claim 9, wherein the density is from 0.950 g/cm³ to 0.960 g/cm³.

11. The hinged component of claim 1, wherein the polyethylene composition has a melt index (MI) of less than 6.9 g/10 min, as determined according to ASTM D1238 (2.16 kg/190° C.).

12. The hinged component of claim 1, wherein the polyethylene composition has a melt index (MI) of from 0.5 to 6.8 g/10 min.

13. A method for making a hinged component, the method comprising:
compression molding or injection molding the hinged component,
wherein the hinged component comprises a polyethylene composition having a melt index (MI) of less than 7 g/10 min as determined according to ASTM D1238 (2.16 kg/190° C.), and a weight average molecular weight (Mw) of more than 170,000.

14. The method of claim 13, wherein the polyethylene composition comprises high density polyethylene having density between 0.945 g/cm³ and 0.960 g/cm³, as determined according to ASTM D792.

15. The method of claim 14, wherein the density is from 0.950 g/cm³ to 0.960 g/cm³, as determined according to ASTM D792.

16. The method of claim 13, wherein the polyethylene composition has one or more characterizations selected from:
a) an Elongation at break (%) of more than 500,
b) a molecular weight distribution (Mw/Mn) of more than 5, and
c) a z-average molecular weight (Mz) of more than 800,000.

17. The method of claim 16, wherein the Mz is from 900,000 to 2,00,000.

18. The method of claim 16, wherein the Mz is from 1,100,000 to 2,000,000.

19. The method of claim 13, wherein the hinged component has a hinge life of at least 1000 cycles.

20. The method of claim 13, wherein the hinged component has chemical resistance of more than 10 days at 60° C.
